(19) United States
(12) Patent Application Publication
(10) Pub. No.: US 2014/0015939 A1
(43) Pub. Date: Jan. 16, 2014

(54) PASSIVE-STEREO THREE-DIMENSIONAL DISPLAYS

(71) Applicants: George Francis Mount, Palo Alto, CA (US); Vivek Menon, San Jose, CA (US)

(72) Inventors: George Francis Mount, Palo Alto, CA (US); Vivek Menon, San Jose, CA (US)

(21) Appl. No.: 13/545,832

(22) Filed: Jul. 10, 2012

(51) Int. Cl. H04N 13/04

(52) U.S. Cl. 348/51; 348/E13.075

(57) ABSTRACT

A passive-stereo three-dimensional display device is described. The display device includes unconventional pixel elements that may display, substantially simultaneously, colors from two image channels using different types of polarized light. The display integrates two polarizing filters over two sets of sub-pixel elements associated with the image channels. In a two-dimensional mode, a single color value may be displayed on both sets of sub-pixel elements to display a single color per pixel. In a three-dimensional mode, two color values may be displayed on the two discrete sets of sub-pixel elements.

### BACKGROUND OF THE INVENTION

1. Field of the Invention

The invention relates generally to display systems and, more specifically, to a passive-stereo, three-dimensional display device.

2. Description of the Related Art

Three-dimensional (3D) displays have recently experienced a surge in popularity in the home consumer market. Many high-definition television sets (HDTVs) include hardware that enables consumers to view 3D content, such as stereoscopic video stored on Blu-ray Disc™ or DVD-ROM (digital versatile disc read only memory). In addition, computer systems typically include some sort of display device, such as a liquid crystal display (LCD) device, coupled to a graphics controller. During normal operation, the graphics controller generates video signals that are transmitted to the display device by scanning-out pixel data from a frame buffer. New software and hardware makes it possible for the graphics controller to generate 3D content that may be viewed on the 3D displays.

One technique for viewing 3D content is implemented via an active stereo vision system. In an active stereo vision system, the content for the left channel and the right channel is interleaved on the display device, with a frame of content for each channel being shown during successive LCD refresh cycles, and a pair of active shutter glasses is synchronized with the display device. Typically, active shutter glasses implement liquid crystal lenses that are alternately made transparent and opaque in coordination with the display of the left and right channels on the display device. When the left channel is displayed on the display device, the left lens is transparent and the right lens is opaque. When the right channel is displayed on the display device, the right lens is transparent and the left lens is opaque. The active shutter glasses and display device are typically run at 120-240 Hz or more, alternately displaying content to the user's left eye and right eye in quick succession. However, each pair of active shutter glasses requires a power supply (i.e., batteries), requires sensors to synchronize shuttering with the display device, and may be heavy and uncomfortable to the user. These specifications make each individual pair of active shutter glasses expensive to purchase and, therefore, consumers are not happy with active stereo vision systems.

As an alternative, another technique for viewing 3D content is implemented via a passive-stereo vision system. In a passive-stereo vision system, the user wears a simple pair of polarized glasses instead of the more complex active shutter glasses. Polarized glasses are lightweight, cheap to produce and easy to find, commonly being available at local movie theaters that show 3D films. However, passive-stereo vision systems require the display device to polarize the light associated with the left channel and the right channel. In movie theaters, polarizing the light for the left channel and right channel is usually implemented by utilizing different projectors for each channel, with each projector passing the light through a different type of polarizing filter. However, the cost of using multiple projectors is usually prohibitive to implement in a consumer device for the home market. More recently, some high-end HDTVs polarize the light for the different channels by implementing a filter on top of an LCD screen that causes the even horizontal lines of pixels to be polarized according to a first polarization associated with one channel and causes the odd horizontal lines of pixels to be polarized according to a second polarization associated with the other channel. During normal operation, two-dimensional content (2D) is viewed on all of the horizontal lines of pixels of the display device in full high-definition resolution (i.e., 1920×1080 for 1080i/1080p or 1280×720 for 720p). However, when viewing 3D content, the left channel may be displayed on half of the horizontal lines while the right channel is displayed on the other half of the horizontal lines.

One drawback to these passive-stereo techniques is that the vertical resolution is effectively cut in half when viewing 3D content when compared to the vertical resolution of the display device when viewing 2D content. In some cases, the display device only displays the pixel information for the odd lines of one channel and the pixel information for the even lines of the other channel, discarding pixel information for any horizontal lines that are associated with a polarizing filter corresponding to a different channel. In some display devices that implement interlaced scanning (i.e., where the odd horizontal lines are updated during a first refresh cycle and then the even horizontal lines are updated during a second refresh cycle), the display device may display the pixel information for horizontal lines of the 3D content on an offset vertical location. For example, during a first scan, the display device displays odd lines for the left channel on the odd horizontal lines of the display device. During a second scan, the display device displays even lines for the right channel on the even horizontal lines of the display device. During a third scan, the display device displays even lines for the left channel on the odd horizontal lines of the display device because displaying the even lines for the left channel on the even horizontal lines of the display device would cause the light to be polarized incorrectly, thus being viewed by the wrong eye. During a fourth scan, the display device displays odd lines for the right channel on the even horizontal lines of the display device. Even though this manner of operation displays the full pixel information of the left and right channel, half of the pixel information for a frame is displayed at an offset spatial location and overlapped with the other half of the frame. This results in a visual artifact that may be disturbing to a viewer that causes the image to appear to jitter as alternating fields are shifted in the vertical direction.

As the foregoing illustrates, what is needed in the art is an improved passive-stereo vision system that enables higher resolution 3D content to be displayed at more accurate pixel locations and spacing.

### SUMMARY OF THE INVENTION

One embodiment of the present invention sets forth a passive-stereo 3D display device. The display device includes a 2D array of pixel elements configured to display pixel data, where each pixel element comprises a first set of sub-pixel elements and a second set of sub-pixel elements. When operating in a 2D mode, the 2D array of pixel elements is configured to display pixel data corresponding to a first image channel via the first set of sub-pixel elements and the second set of sub-pixel elements. When operating in a 3D mode, the 2D array of pixel elements is configured to display pixel data corresponding to the first image channel via the first set of sub-pixel elements and to display pixel data corresponding to a second image channel via the second set of sub-pixel elements.

Another embodiment of the present invention sets forth a passive-stereo 3D video system. The video system includes a video source device and the display device described above coupled to the video source device via a video interface.

One advantage of the disclosed technique is that, regardless of whether the display device is configured to operate in a 2D mode or a 3D mode, the pixel data for the image channels may be displayed at full resolution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a parallel processing subsystem coupled to a display device, according to one embodiment of the present invention;

FIG. 3 illustrates a 2D pixel array such as the LCD device of FIG. 2, according to one embodiment of the present invention;

FIGS. 4A and 4B illustrate a conventional pixel element implemented in a typical LCD display device;

FIGS. 5A, 5B, and 5C illustrate a pixel element of the LCD device of FIG. 2 that includes two sets of liquid crystal sub-pixel elements, according to one embodiment of the present invention;

FIGS. 6A, 6B, and 6C illustrate a pixel element, according to another embodiment of the present invention;

FIGS. 7A, 7B, and 7C illustrate a pixel element, according to yet another embodiment of the present invention; and

FIGS. 8A, 8B, 8C, and 8D illustrate various sub-pixel element arrangements for the pixel elements of the LCD device of FIG. 2, according to other embodiments of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

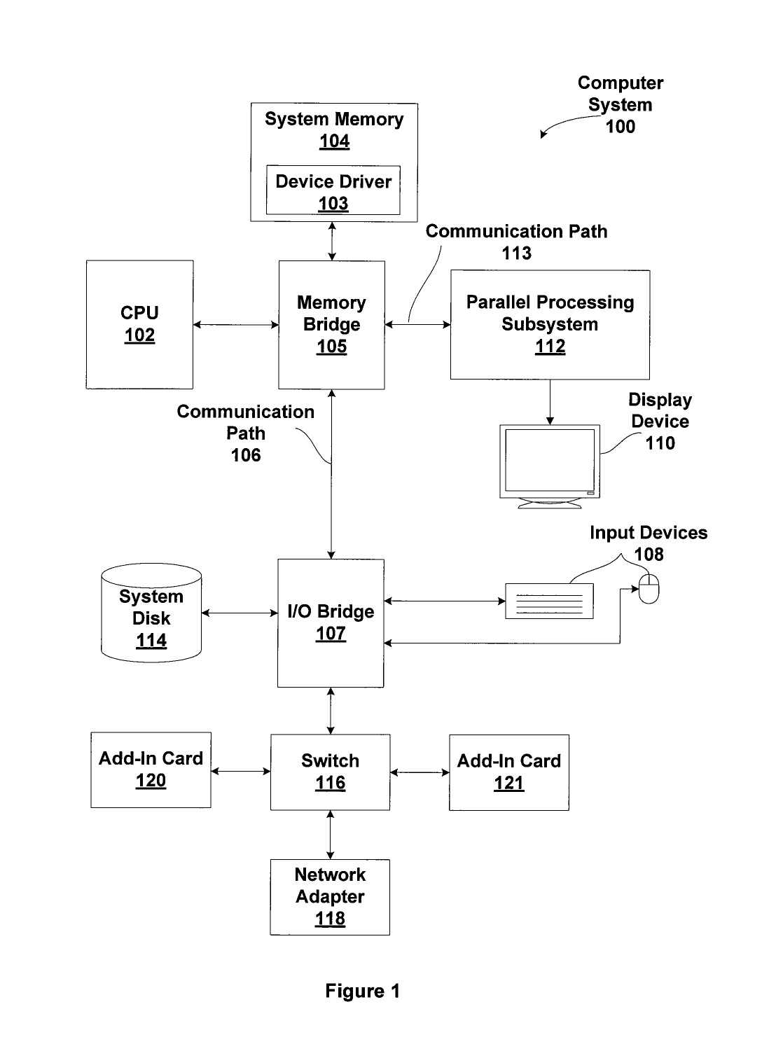

FIG. 1 is a block diagram illustrating a computer system 100 configured to implement one or more aspects of the present invention. The computer system 100 may be a desktop computer, laptop computer, handheld device, cellular phone, PDA (personal digital assistant), tablet computer, camera, or other well-known types of consumer electronic devices.

As shown in FIG. 1, computer system 100 includes, without limitation, a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect Express (PCIe), Accelerated Graphics Port (AGP), or HyperTransport link); in one embodiment parallel processing subsystem 112 is a graphics subsystem that delivers pixels to a display device 110 (e.g., a conventional cathode ray tube or liquid crystal display based monitor). Memory 104 includes a device driver 103 configured to transmit commands and data to parallel processing subsystem 112. A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) or other port connections, compact disc (CD) drives, digital video disc (DVD) drives, film recording devices, and the like, may also be connected to I/O bridge 107. The various communication paths shown in FIG. 1, including the specifically named communications paths 106 and 113, may be implemented using any suitable protocols, such as PCIe, AGP, HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

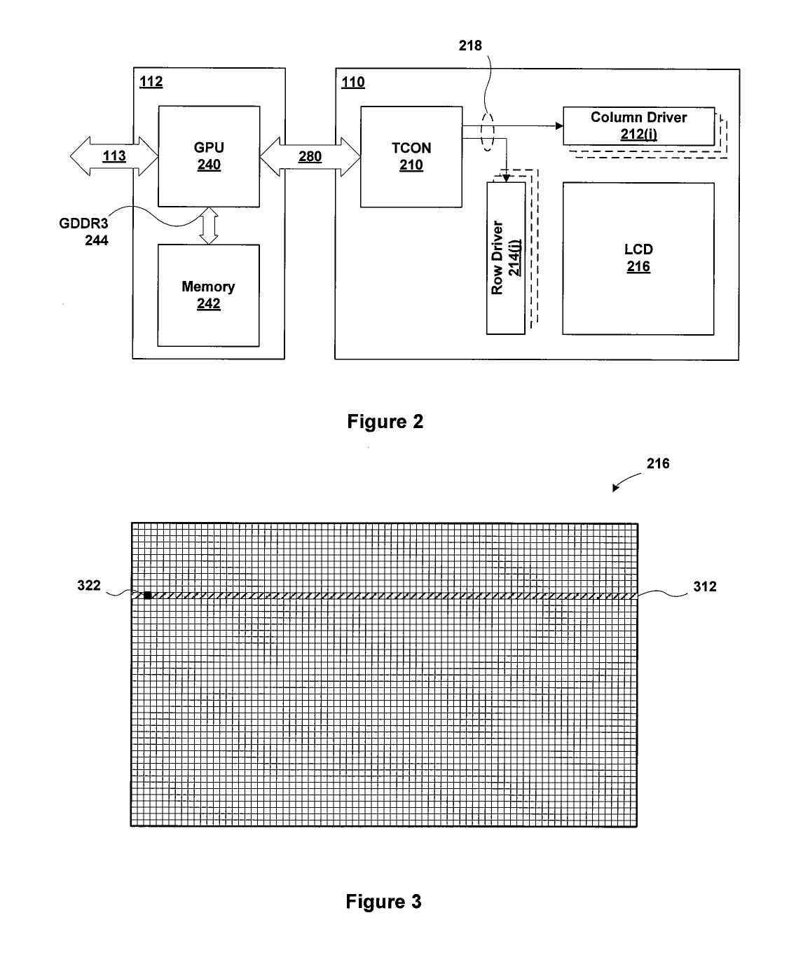

FIG. 2 illustrates a parallel processing subsystem 112 coupled to a display device 110, according to one embodiment of the present invention. As shown, parallel processing subsystem 112 includes a graphics processing unit (GPU) 240 coupled to a graphics memory 242 via a GDDR3 (graphics double data rate 3) bus interface 244. Graphics memory 242 may include one or more frame buffers for storing pixel information rendered by the GPU 240 for output to display device 110. Parallel processing subsystem 112 is configured to generate video signals based on pixel data stored in the frame buffers and transmit the video signals to display device 110 via communications path 280.

GPU 240 may be configured to receive graphics primitives from CPU 102 via communications path 113. GPU 240 processes the graphics primitives to produce a frame of pixel data for display on display device 110 and stores the frame of pixel data in the frame buffers in graphics memory 242. In normal operation, GPU 240 is configured to scan out pixel data from the frame buffers to generate video signals for display on display device 110. In one embodiment, GPU 240 is configured to generate a digital video signal and transmit the digital video signal to display device 110 via a digital video interface such as an LVDS, a DVI, an HDMI, a DisplayPort (DP), or an embedded DisplayPort (eDP) interface. In another embodiment, GPU 240 may be configured to generate an analog video signal and transmit the analog video signal to display device 110 via an analog video interface such as a VGA or DVI-A interface. In embodiments where communications path 280 implements an analog video interface, display device 110 may convert the received analog video signal into a digital video signal by sampling the analog video signal with one or more analog to digital converters.

As also shown in FIG. 2, display device 110 includes a timing controller (TCON) 210, a liquid crystal display (LCD) device 216, one or more column drivers 212(i), and one or more row drivers 214(j). TCON 210 generates video timing signals for driving LCD device 216 via the column drivers 212 and row drivers 214. TCON 210 stores the video signals received via communications path 280 in buffers and refreshes the various pixels of the LCD device 216 according to the pixel information included in the video signals by transmitting signals to the column divers 212 and row drivers 214. TCON 210 may transmit pixel data to column drivers 212 and row drivers 214 via a communication interface 218, such as a mini LVDS interface.

Display device 110 is configured to operate in two distinct modes, a 2D mode and a 3D mode. In the 2D mode, the video signals received via communications path 280 include pixel information for a single image channel. For each frame of video, the 2D video signals include pixel data for a number of pixels at the particular resolution specified by the video signals. For example, for 2D video signals corresponding to full 1080p resolution, the 2D video signals include pixel data for over 2 million pixels per frame (i.e., 1920×1080). The TCON 210 receives the pixel information for a frame of video and updates every horizontal line of pixels in the LCD device 216 during the next screen refresh cycle based on the pixel information encoded in the video signals.

FIG. 3 illustrates a 2D pixel array such as the LCD device 216 of FIG. 2, according to one embodiment of the present invention. As shown in FIG. 3, LCD device 216 is comprised of a 2D array of LCD pixel elements 322. For illustration purposes only, the 2D array of pixel elements 322 is 80 pixel elements in width and 48 pixel elements in height. The pixel elements 322 are arranged in equally spaced horizontal rows 312. In practice, LCD device 216 may include many more pixel elements 322 corresponding to a native resolution of the LCD device 216. Again, for a full 1080p resolution, LCD device 216 includes over 2 million pixel elements 322 arranged in 1080 equal length rows.

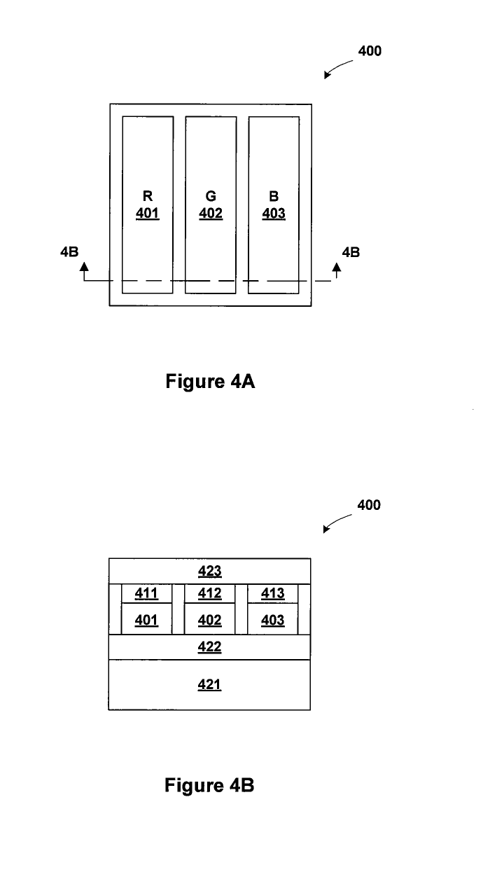

FIGS. 4A and 4B illustrate a conventional pixel element 400 implemented in a typical LCD display device. As shown in FIG. 4A, the conventional pixel element 400 includes three liquid crystal sub-pixel elements 401, 402, and 403 associated with different color filters. FIG. 4B shows a cross-section view of the conventional pixel element 400. As shown in FIG. 4B, a first liquid crystal sub-pixel element 401 is associated with a red color filter 411, a second liquid crystal sub-pixel element 402 is associated with a green color filter 412, and a third liquid crystal sub-pixel element 403 is associated with a blue color filter 413. Each of the liquid crystal sub-pixel elements (e.g., 401, 402, and 403) is driven by an electric field at a particular voltage level specified by a different color channel of the pixel data to generate a composite color for that pixel.

A backlight 421, such as cold cathode fluorescent lights (CCFL), edge LEDs, or an LED array, generates white light that projects through a rear glass panel 422 having a rear polarizing filter integrated therein. In some embodiments, the rear glass panel 422 and the rear polarizing filter may be separate components layered within the pixel element 400. The rear polarizing filter is associated with a first polarization orientation that generates polarized white light that is transmitted through the rest of the components of the pixel element 400. The polarized white light then passes through each of the liquid crystal sub-pixel elements (e.g., 401, 402, and 403), which change the orientation of the polarization of the light based on the voltage applied to the liquid crystal sub-pixel element. The polarized white light then passes through a color filter (e.g., 411, 412, 413), and a front glass panel 423 having a front polarizing filter integrated therein. The front polarizing filter is oriented such that a second polarization orientation of the front polarizing filter is orthogonal to the first polarization orientation of the rear polarizing filter. As is well-known, some types of liquid crystals exhibit a twisted-nematic field effect that enables the molecules in the liquid crystal structure to twist in reaction to an applied voltage, which also causes a corresponding change in the polarization of light passing through the liquid crystal. The amount of twist applied to the liquid crystals changes the amount of light that passes through the set of orthogonal polarizing filters and, therefore, the resulting color produced by the pixel element 400.

Returning now to FIG. 2, in the 3D mode, the video signals received via communications path 280 include pixel information for two or more image channels. In the case of stereoscopic video, the video signals include pixel information for two image channels: (1) a left image channel, and (2) a right image channel. For each frame of video, the 3D video signals include pixel data for all of the pixels at the full resolution of the video signals for both the left image channel and the right image channel, effectively increasing the bandwidth for transmitting the 3D video signals to be approximately twice the bandwidth for transmitting the 2D video signals. In other words, each distinct pixel element 322 in the LCD device 216 is associated with two separate color values for a single frame, a first color value associated with the left image channel and a second color value associated with the right image channel.

It will be appreciated that the present invention is described with reference to computer system 100 and display device 110 where parallel processing system 112 implements a video source device and display device 110 displays pixel data transmitted from the video source device to LCD device 216 via a video interface. However, other passive-stereo 3D video systems are contemplated such as where the video source device is a set top box (e.g., a cable box, satellite receiver, etc.) that is configured to transmit pixel information to a high definition television (HDTV), which implements a 2D pixel array such as LCD device 216. HDTVs, LCD monitors, AMOLED displays and other types of display technologies that implement 2D arrays of pixel elements are contemplated as being within the scope of the present invention.

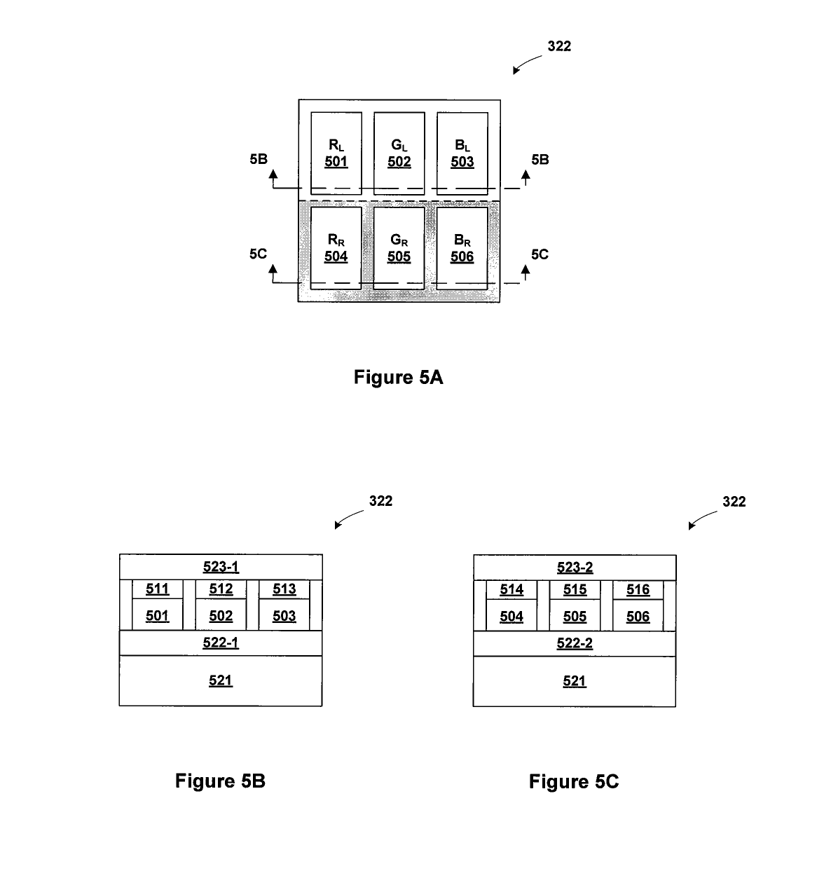

FIGS. 5A, 5B, and 5C illustrate a pixel element 322 of the LCD device 216 of FIG. 2 that includes two sets of liquid crystal sub-pixel elements, according to one embodiment of the present invention. As shown in FIG. 5A, the pixel element 322 is divided into a top portion that includes a first set of liquid crystal sub-pixel elements (i.e., 501, 502, and 503) and a bottom potion that includes a second set of liquid crystal sub-pixel elements (i.e., 504, 505, and 506). The first set of liquid crystal sub-pixel elements correspond to a first image channel of pixel data and the second set of liquid crystal sub-pixel elements correspond to a second image channel of pixel data. Thus, the same pixel element 322 may display a red color value specified by the first image channel in a first red liquid crystal sub-pixel element 501 and, simultaneously, display a red color value specified by the second image channel in a second red liquid crystal sub-pixel element 504. Similarly, two green color values may be displayed in a first green liquid crystal sub-pixel element 502 and a second green liquid crystal sub-pixel element 505 and two blue color values may be displayed in a first blue liquid crystal sub-pixel element 503 and a second blue liquid crystal sub-pixel element 506. Pixel element 322 in FIG. 5A shares substantially the same footprint in an LCD device as a conventional pixel element 400.

FIG. 5B shows a cross-section view of the pixel element 322 taken through the first set of liquid crystal sub-pixel elements (i.e., 501, 502, and 503) in a top portion of the pixel element 322. Each of the liquid crystal sub-pixel elements in the first set is driven by an electric field at a particular voltage level specified by a different color channel of the first image channel included in the pixel data. A backlight 521, similar to backlight 421, generates white light that projects through a first rear glass panel 522-1 having a first rear polarizing filter integrated therein, each of the liquid crystal sub-pixel elements (e.g., 501, 502, and 503) in the first set, a corresponding color filter (e.g., 511, 512, and 513), and a first front glass panel 523-1 having a first front polarizing filter integrated therein. Similarly, FIG. 5C shows a cross-section view of the pixel element 322 taken through the second set of liquid crystal sub-pixel elements (i.e., 504, 505, and 506) in a bottom portion of the pixel element 322. The backlight 521 generates white light that projects through a second rear glass panel 522-2 having a second rear polarizing filter integrated therein, each of the liquid crystal sub-pixel elements (e.g., 504, 505, and 506) in the second set, a corresponding color filter (e.g., 514, 515, and 516), and a second front glass panel 523-2 having a second front polarizing filter integrated therein.

The first front glass panel 523-1 and first front polarizing filter associated with the first set of liquid crystal sub-pixel elements (i.e., 501, 502, and 503) is configured to polarize the light according to a first polarization orientation and the second front glass panel 523-2 and second front polarizing filter associated with the second set of liquid crystal sub-pixel elements (i.e., 514, 515, and 516) is configured to polarize the light according to a second polarization orientation that is different than the first polarization orientation. The difference between the first polarization orientation and the second polarization orientation enables polarized glasses to be worn by a user that allows light from the first set of liquid crystal sub-pixel elements to reach a first eye of the user and light from the second set of liquid crystal sub-pixel elements to reach a second eye of the user.

In one embodiment, the first rear polarizing filter may be a first linear polarizing filter in a first orientation and the first front polarizing filter may be a combination of a second linear polarizing filter in a second orientation and a first quarter-wave retarder in a third orientation with respect to the second linear polarizing filter. The first and second linear polarizing filters cause light passing through the first set of liquid crystal sub-pixel elements to be attenuated based on the voltage applied to each of the liquid crystal sub-pixel elements. Then, the relative orientation of the first quarter-wave retarder and the second linear polarizing filter causes the light transmitted through the first set of liquid crystal sub-pixel elements to be circularly polarized in either a left-handed or right-handed manner.

Similarly, the second rear polarizing filter may be a third linear polarizing filter in a fourth orientation and the second front polarizing filter may be a combination of a fourth linear polarizing filter in a fifth orientation and a second quarter-wave retarder in a sixth orientation with respect to the fourth linear polarizing filter. The third and fourth linear polarizing filters cause light passing through the second set of liquid crystal sub-pixel elements to be attenuated based on the voltage applied to each of the liquid crystal sub-pixel elements. Then, the relative orientation of the second quarter-wave retarder plate and the fourth linear polarizing filter causes the light transmitted through the second set of liquid crystal sub-pixel elements to be circularly polarized in the opposite handedness from the light transmitted through the first set of liquid crystal sub-pixel elements.

In one embodiment, the first rear glass panel 522-1 and the second rear glass panel 522-2 are a single rear glass panel that extends over a plurality of pixel elements in the LCD device. The single rear glass panel may incorporate a rear linear polarizing filter in a first orientation. Similarly, the first front glass panel 523-1 and the second front glass panel 523-2 are a single rear glass panel that extends over a plurality of pixel elements in the LCD device. The single front glass panel may incorporate a front linear polarizing filter in a second orientation that is orthogonal to the first orientation. In this manner, each of the sub-pixel elements transmits light through the front glass panel polarized according to the second orientation. A first quarter-wave retarder for each of the first set of liquid crystal sub-pixel elements and a second quarter-wave retarder for each of the second set of liquid crystal sub-pixel elements may then be overlaid on top of the single front glass panel such that the first quarter-wave retarder is oriented in one orientation relative to the orientation of the front linear polarizing filter and the second quarter-wave retarder is oriented in a different orientation relative to the orientation of the front linear polarizing filter.

The quarter-wave retarders may be implemented as a film laminated on a front side of the front glass panel or laminated on a glass plate that is placed in front of the front glass panel. For example, the first quarter-wave retarder may comprise a birefringent material laminated to a first side of a glass substrate. The second quarter-wave retarder may comprise a birefringent material laminated to a second side of the glass substrate. The birefringement materials may be manufacturer such that the material on the first side has a first orientation and the material on the second side has a second orientation orthogonal to the first orientation. Birefringent material may be removed from regions of the first side of the glass substrate corresponding to any liquid crystal sub-pixel elements in the second set, and birefringent material may be removed from regions of the second side of the glass substrate corresponding to any liquid crystal sub-pixel elements in the first set, wherein the regions of the first side and the regions of the second side do not overlap in any area associated with liquid crystal sub-pixel elements.

Again, the ICON 210 receives the pixel information for a frame of video and updates every horizontal line of pixels 312 in the LCD device 216 during the next screen refresh cycle. However, in the 3D mode, each pixel element 322 in the LCD device 216 includes two sets of liquid crystal sub-pixel elements, where each set of liquid crystal sub-pixel elements corresponds to a different image channel of the pixel data. Thus, the column drivers 212 and the row drivers 214 may be configured to update a first set of liquid crystal sub-pixel elements for a first image channel (e.g., the left stereoscopic image) and a second set of liquid crystal sub-pixel elements for a second image channel (e.g., the right stereoscopic image). In one embodiment, the column driver 212 may include additional control signals that enable the column driver 212 to address separate and distinct sets of liquid crystal sub-pixel elements within each of the pixel elements 322 of LCD device 216.

During 2D operation, the video signals include a single image channel which is displayed on both the first set of liquid crystal sub-pixel elements and the second set of liquid crystal sub-pixel elements substantially simultaneously. Thus, pixel element 322 behaves similarly to a conventional pixel element 400. However, during 3D operation, the first set of liquid crystal sub-pixel elements is driven separately from the second set of liquid crystal sub-pixel elements, enabling two colors to be emitted from the pixel element 322 using light polarized at different polarization orientations.

In one embodiment, the intensity of the backlight 521 may be adjusted when the display device 110 is switched between a 2D mode and a 3D mode. As shown in FIG. 5A, the footprints of the liquid crystal sub-pixel elements (e.g., 501, 502, etc.) in pixel element 322 are smaller than the footprints of the liquid crystal sub-pixel elements (e.g., 401, 402, etc.) in conventional pixel element 400 of FIG. 4A. In the 2D mode, two liquid crystal sub-pixel elements are operated in tandem (e.g., 501 and 504, 502 and 505, and 503 and 506), thereby having a combined footprint that is similar to the footprint of one liquid crystal sub-pixel element (e.g., 401, 402, etc.) in pixel element 400. However, when operating in the 3D mode, light from only a single liquid crystal sub-pixel element (e.g., 501 or 504) reaches each eye. The backlight 521 intensity may be increased to account for the decreased light intensity emitted from the single liquid crystal sub-pixel element in the 3D mode when compared to the light intensity emitted from two liquid crystal sub-pixel elements in the 2D mode.

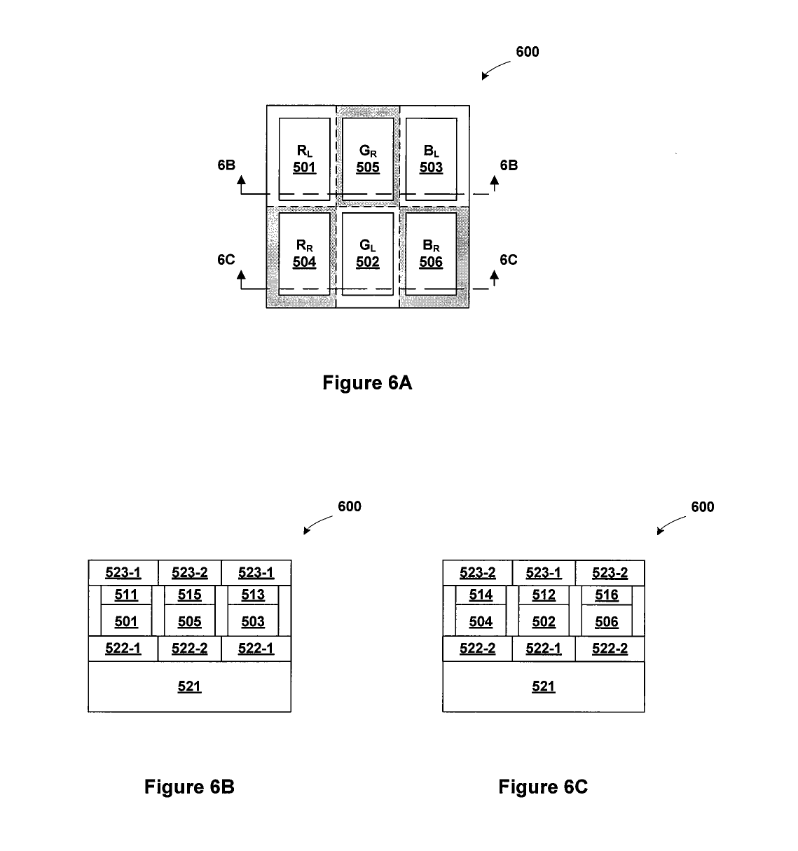

FIGS. 6A, 6B, and 6C illustrate a pixel element 600, according to another embodiment of the present invention. Pixel element 600 of FIG. 6A is similar to pixel element 322 of FIG. 5A and may be incorporated into LCD device 216 as an array of pixel elements 600 in lieu of the array of pixel elements 322. As shown in FIG. 6A, pixel element 600 includes a first set of liquid crystal sub-pixel elements (i.e., 501, 502, and 503) corresponding to the first image channel and a second set of liquid crystal sub-pixel elements (i.e., 504, 505, and 506) corresponding to the second image channel. Referring back to pixel element 322 of FIG. 5A, the first set of liquid crystal sub-pixel elements (i.e., 501, 502, and 503) is aligned horizontally in a top portion of the pixel element 322 and the second set of liquid crystal sub-pixel elements (i.e., 504, 505, and 506) is aligned horizontally in a bottom portion of the pixel element 322. As FIG. 5A shows, the polarizing filters may be manufactured in horizontal lines over a horizontal line of liquid crystal sub-pixel elements where a first front glass panel 523-1 having a first front polarizing filter are overlaid on a top portion of the horizontal line of pixel elements and a second front glass panel 523-2 having a second front polarizing filter are overlaid on a bottom portion of the horizontal line of pixel elements.

Returning back to pixel element 600 of FIG. 6A, the first set of liquid crystal sub-pixel elements (i.e., 501, 502, and 503) corresponding to the first image channel are alternately arranged in either the top portion of the pixel element 600 or the bottom portion of the pixel element 600. Similarly, the second set of liquid crystal sub-pixel elements (i.e., 504, 505, and 506) are alternately arranged in either the top portion of the pixel element 600 or the bottom portion of the pixel element 600. The arrangement shown in pixel element 322 of FIG. 5A may suffer from spatial artifacts because horizontal lines of pixels in a left image are shown above horizontal lines of pixels in a right image, offsetting corresponding pixel color values in a vertical direction by an offset equal to approximately half the pixel element height. In effect, the left and right images will be out of alignment in the vertical dimension. In contrast, the arrangement of liquid crystal sub-pixel elements in pixel element 600 interleaves the color components of the color value from the first image channel with the color components of the color value from the second image channel. Spatial artifacts from the sub-pixel element arrangement shown in FIG. 5A may be reduced using the sub-pixel element arrangement of FIG. 6A.

FIGS. 6B and 6C show cross-section views of the pixel element 600 taken through the top portion of the pixel element 600 and the bottom portion of the pixel element 600, respectively. As shown in FIG. 6B, the top portion of the pixel element 600 includes a first liquid crystal sub-pixel element 501 associated with a red color filter 511, a second liquid crystal sub-pixel element 505 associated with a green color filter 515, and a third liquid crystal sub-pixel element 503 associated with a blue color filter 513. The first liquid crystal sub-pixel element 501 and the third liquid crystal sub-pixel element 503 correspond to a first image channel, and the second liquid crystal sub-pixel element 505 corresponds to a second image channel. The first liquid crystal sub-pixel element 501 and the third liquid crystal sub-pixel element 503 are layered between a first rear glass panel 522-1 having a first polarizing filter integrated therein and a first front glass panel 523-1 having a second polarizing filter integrated therein. The second liquid crystal sub-pixel element 505 is layered between a second rear glass panel 522-2 having a third polarizing filter integrated therein and a second front glass panel 523-2 having a fourth polarizing filter integrated therein.

Similarly, as shown in FIG. 6C, the bottom portion of the pixel element 600 includes a first liquid crystal sub-pixel element 504 associated with a red color filter 514, a second liquid crystal sub-pixel element 502 associated with a green color filter 512, and a third liquid crystal sub-pixel element 506 associated with a blue color filter 516. The first liquid crystal sub-pixel element 504 and the third liquid crystal sub-pixel element 506 correspond to a second image channel, and the second liquid crystal sub-pixel element 502 corresponds to a first image channel. The first liquid crystal sub-pixel element 504 and the third liquid crystal sub-pixel element 506 are layered between the second rear glass panel 522-2 having the third polarizing filter integrated therein and the second front glass panel 523-2 having the fourth polarizing filter integrated therein. The second liquid crystal sub-pixel element 502 is layered between the first rear glass panel 522-1 having the first polarizing filter integrated therein and the first front glass panel 523-1 having the second polarizing filter integrated therein.

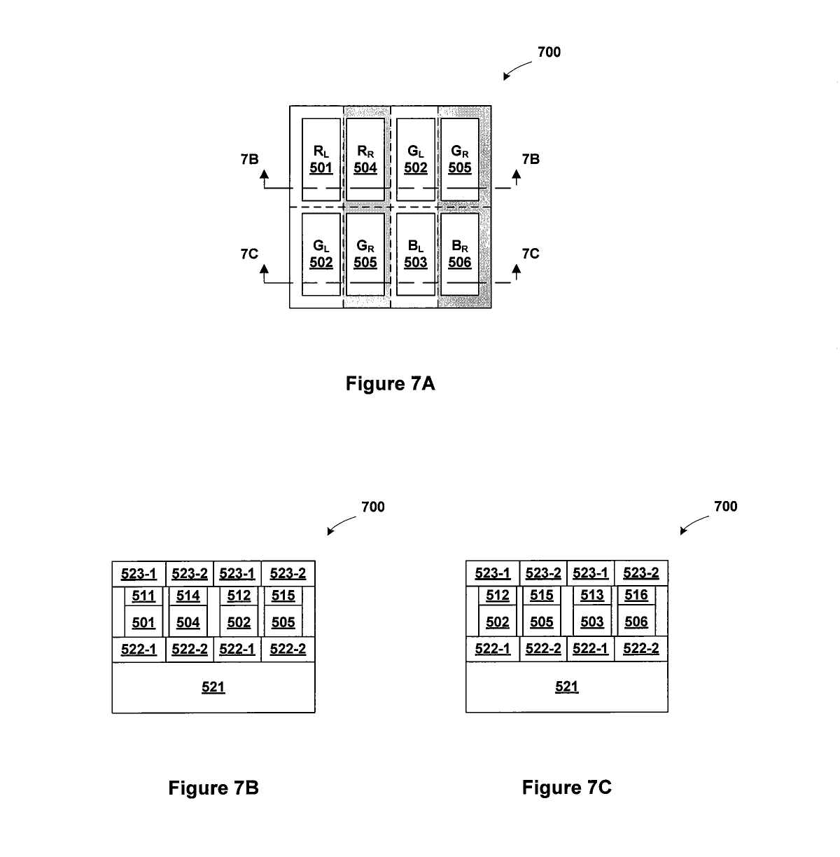

FIGS. 7A, 7B, and 7C illustrate a pixel element 700, according to yet another embodiment of the present invention. Pixel element 700 of FIG. 7A is similar to pixel element 322 of FIG. 5A and may be incorporated into LCD device 216 as an array of pixel elements 700 in lieu of the array of pixel elements 322. The sub-pixel element arrangement illustrated in FIG. 7A is similar to a Bayer mosaic pattern incorporated into current conventional CMOS image sensors and, therefore, may more accurately reflect raw image sensor data captured by such images sensors. As is known to those of ordinary skill in the art, a Bayer mosaic pattern color filter array consists of alternating horizontal lines of color filters in a two dimensional array, where even lines consist of alternate red and green color filters and odd lines consist of alternate green and blue color filters, such that any 2×2 array of color filters includes 2 green color filters, 1 red color filter, and 1 blue color filter. As shown in FIG. 7A, pixel element 700 is subdivided into four quadrants. The upper left quadrant of pixel element 700 includes a first red liquid crystal sub-pixel element 501 and a second red liquid crystal sub-pixel element 504. The upper right quadrant of pixel element 700 includes a first green liquid crystal sub-pixel element 502 and a second green liquid crystal sub-pixel element 505. The lower left quadrant of pixel element 700 includes a third green liquid crystal sub-pixel element 502 and a fourth green liquid crystal sub-pixel element 505, which operate in tandem with the first green liquid crystal sub-pixel element 502 and the second green liquid crystal sub-pixel element 505 in the upper right quadrant of pixel element 700, respectively. The lower right quadrant of pixel element 700 includes a first blue liquid crystal sub-pixel element 503 and a second blue liquid crystal sub-pixel element 506.

As shown in FIGS. 7B and 7C, the first set of liquid crystal sub-pixel elements (i.e., 501, 502, and 503) is layered between the first rear glass panel 522-1 having the first polarizing filter integrated therein and the first front glass panel 523-1 having the second polarizing filter integrated therein. The second set of liquid crystal sub-pixel elements (i.e., 504, 505, and 506) is layered between the second rear glass panel 522-2 having the third polarizing filter integrated therein and the second front glass panel 523-2 having the fourth polarizing filter integrated therein.

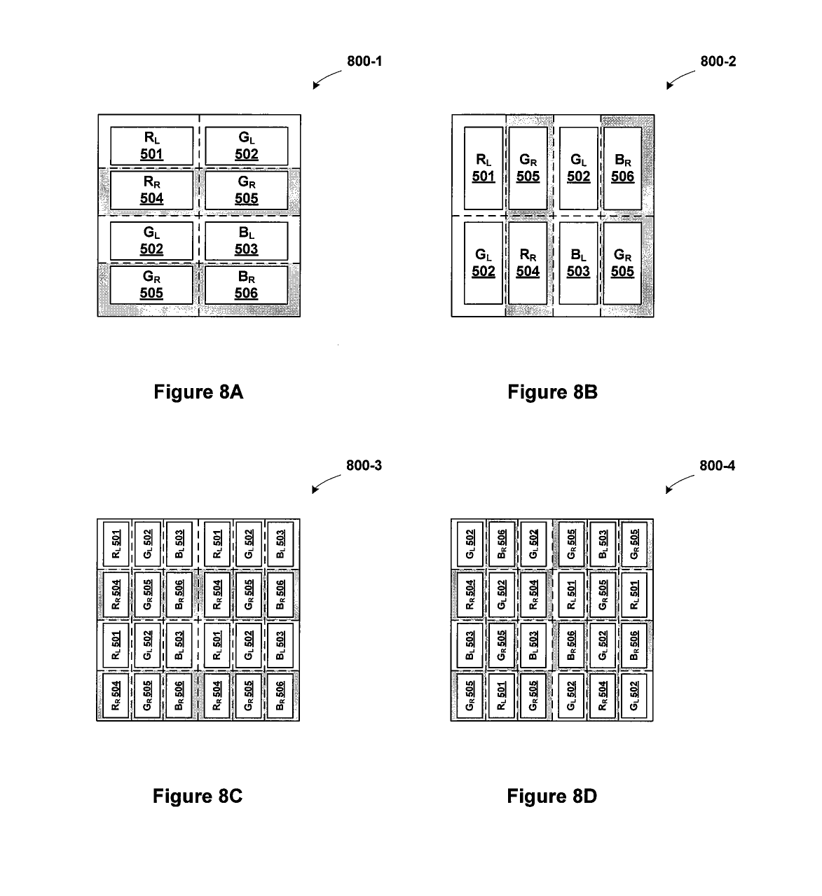

FIGS. 8A, 8B, 8C, and 8D illustrate various sub-pixel element arrangements for the pixel elements 322 of the LCD device 216 of FIG. 2, according to other embodiments of the present invention. As shown by FIG. 8A, the orientation of the sub-pixel element arrangement shown in FIG. 7A may be changed such that the front polarizing filters are arranged in horizontal rows instead of vertical rows within pixel element 800-1. As shown by FIG. 8B, the arrangement of sub-pixel elements may place a first sub-pixel element associated with a first color channel included in the first image channel adjacent to a second sub-pixel element associated with a second color channel included in the second image channel within the same quadrant of the pixel element 800-2. Such an arrangement places sub-pixel elements associated with different colors in the same quadrant of the pixel element.

In some embodiments, each color channel for each image channel may be associated with two or more liquid crystal sub-pixel elements within each pixel element. For example, as shown in FIG. 8C, each color channel in each image channel is associated with four separate and distinct liquid crystal sub-pixel elements. A first red color channel in a first image channel is associated with four red liquid crystal sub-pixel elements 501, a first green color channel in the first image channel is associated with four green liquid crystal sub-pixel elements 502, and a first blue color channel in the first image channel is associated with four blue liquid crystal sub-pixel elements 503. Similarly, a second red color channel in a second image channel is associated with four red liquid crystal sub-pixel elements 504, a second green color channel in the second image channel is associated with four green liquid crystal sub-pixel elements 505, and a second blue color channel in the second image channel is associated with four blue liquid crystal sub-pixel elements 506. The first set of liquid crystal sub-pixel elements (i.e., 501, 502, and 503) is arranged in the top portion of each quadrant of pixel element 800-3 and the second set of liquid crystal sub-pixel elements (i.e., 504, 505, and 506) is arranged in the bottom portion of each quadrant of pixel element 800-3. This sub-pixel element arrangement enables the first front glass panel 523-1 having a first front polarizing filter and the second front glass panel 523-2 having a second front polarizing filter to be arranged in horizontal rows laid over the top of the plurality of sub-pixel elements.

FIG. 8D illustrates an alternate arrangement of sub-pixel elements where the first set of liquid crystal sub-pixel elements is interleaved in a checkerboard pattern with the second set of liquid crystal sub-pixel elements. The upper left quadrant of pixel element 800-4 includes six liquid crystal sub-pixel elements: three liquid crystal sub-pixel elements 502 associated with a first green color channel in a first image channel, two liquid crystal sub-pixel elements 504 associated with a second red color channel in a second image channel, and one liquid crystal sub-pixel element 506 associated with a second blue color channel in the second image channel. The upper right quadrant of pixel element 800-4 includes six liquid crystal sub-pixel elements: three liquid crystal sub-pixel elements 505 associated with a second green color channel in the second image channel, two liquid crystal sub-pixel elements 501 associated with a first red color channel in the first image channel, and one liquid crystal sub-pixel element 503 associated with a first blue color channel in the first image channel. The lower left quadrant of pixel element 800-4 includes six liquid crystal sub-pixel elements: three liquid crystal sub-pixel elements 505 associated with the second green color channel in the second image channel, two liquid crystal sub-pixel elements 503 associated with the first blue color channel in the first image channel, and one liquid crystal sub-pixel element 501 associated with the first red color channel in the first image channel. The lower right quadrant of pixel element 800-4 includes six liquid crystal sub-pixel elements: three liquid crystal sub-pixel elements 502 associated with the first green color channel in the first image channel, two liquid crystal sub-pixel elements 506 associated with the second blue color channel in the second image channel, and one liquid crystal sub-pixel element 504 associated with the second red color channel in the second image channel.

It will be appreciated that the present invention has been described in relation to LCD pixel elements. However, other types of pixel elements are contemplated as being within the scope of the present invention. For example, LCD device 216 may be replaced with an array of plasma pixel elements, wherein each plasma pixel element includes a plasma sub-pixel element comprising a micro-cavity filled with an ionized gas and coated with a phosphor material that, when excited by an electrode, causes the phosphor material to glow a particular color. In this case, there are no linear polarizing filters integrated within the front and rear glass panel, and only the quarter-wave retarders are needed to polarize light from the first and second sets of plasma sub-pixel elements.

In sum, the disclosed technique enables pixel data associated with two distinct image channels (e.g., a left image and a right image) to be displayed at full resolution substantially simultaneously on a passive, stereo-vision three-dimensional display device. In a 2D mode, pixel data for one image channel is displayed simultaneously on two sets of liquid crystal sub-pixel elements. In a 3D mode, pixel data for a first image channel is displayed on a first set of liquid crystal sub-pixel elements and pixel data for a second image channel is displayed on a second set of liquid crystal sub-pixel elements.

One advantage of the disclosed system is that regardless of whether the display device is configured to operate in a 2D mode or a 3D mode, the pixel data for the image channels is always displayed at full resolution. In conventional passive-stereo display devices, while pixel data for one image channel may be displayed in full resolution when operating in a 2D mode, pixel data for two image channels is only displayed at half the resolution, utilizing half of the pixel elements for each of the image channels.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A passive-stereo three-dimensional (3D) display device, comprising:
a two-dimensional (2D) array of pixel elements configured to display pixel data, wherein each pixel element comprises a first set of sub-pixel elements and a second set of sub-pixel elements,
wherein, when operating in a 2D mode, the 2D array of pixel elements is configured to display pixel data corresponding to a first image channel via the first set of sub-pixel elements and the second set of sub-pixel elements, and, when operating in a 3D mode, the 2D array of pixel elements is configured to display pixel data corresponding to the first image channel via the first set of sub-pixel elements and to display pixel data corresponding to a second image channel via the second set of sub-pixel elements.

2. The display device of claim 1, wherein each set of sub-pixel elements comprises a red sub-pixel element, a green sub-pixel element, and a blue sub-pixel element.

3. The display device of claim 1, wherein the 2D array of pixel elements comprises an LCD array.

4. The display device of claim 3, wherein the LCD array comprises:
a backlight;
a rear glass panel having a first polarizing filter included therein;
a plurality of liquid crystal sub-pixel elements;
a color filter array; and
a front glass panel having a second polarizing filter included therein.

5. The display device of claim 4, wherein the first polarizing filter comprises a first linear polarizing filter having a first polarization orientation.

6. The display device of claim 5, wherein the second polarizing filter comprises:
a second linear polarizing filter having a second polarization orientation; and
a quarter-wave retarder.

7. The display device of claim 6, wherein the quarter-wave retarder comprises a first layer including a first plurality of regions of birefringent material having a third polarization orientation relative to the second polarization orientation and a second layer including a second plurality of regions of birefringent material having a fourth polarization orientation relative to the second polarization orientation, and wherein the first plurality of regions are located above the first set of sub-pixel elements and the second plurality of regions are located above the second set of sub-pixel elements.

8. The display device of claim 1, wherein each pixel element is subdivided into a top portion and a bottom portion, and wherein the first set of sub-pixel elements is arranged along horizontal rows within the top portion and the second set of sub-pixel elements is arranged along horizontal rows within the bottom portion.

9. The display device of claim 1, wherein each pixel element is subdivided into a top portion and a bottom portion, and wherein a subset of the first set of sub-pixel elements is arranged within the top portion and a remainder of the first set of sub-pixel elements is arranged within the bottom portion, and a subset of the second set of sub-pixel elements is arranged within the bottom portion and a remainder of the second set of sub-pixel elements is arranged within the top portion.

10. The display device of claim 1, wherein each pixel element is subdivided into quadrants that include one or more sub-pixel elements from each of the first set of sub-pixel elements and the second set of sub-pixel elements.

11. The display device of claim 10, wherein the sub-pixel elements are arranged according to a Bayer mosaic filter pattern that includes twice as many green sub-pixel elements as red sub-pixel elements or blue sub-pixel elements.

12. The display device of claim 1, wherein each pixel element is subdivided into a plurality of regions that include one sub-pixel element, and wherein the sub-pixel elements are arranged in a checkerboard pattern such that no region including a sub-pixel element included in the first set of sub-pixel elements is directly adjacent to any region including any other sub-pixels element included in the first set of sub-pixel elements.

13. The display device of claim 1, wherein each pixel element includes two or more sub-pixel elements associated with each particular color channel of the first image channel and the second image channel.

14. The display device of claim 1, further comprising:
a timing controller configured to determine whether video signals received from a video source include pixel data for one image channel or two image channels;
one or more column drivers; and
one or more row drivers.

15. A passive-stereo three-dimensional (3D) video system, comprising:
a video source device; and
a display device coupled to the video source device via a video interface, the display device comprising:
a two-dimensional (2D) array of pixel elements configured to display pixel data, wherein each pixel element comprises a first set of sub-pixel elements and a second set of sub-pixel elements,
wherein, when operating in a 2D mode, the 2D array of pixel elements is configured to display pixel data corresponding to a first image channel via the first set of sub-pixel elements and the second set of sub-pixel elements, and, when operating in a 3D mode, the 2D array of pixel elements is configured to display pixel data corresponding to the first image channel via the first set of sub-pixel elements and to display pixel data corresponding to a second image channel via the second set of sub-pixel elements.

16. The video system of claim 15, wherein the 2D array of pixel elements comprises an LCD array that includes:
a backlight;
a rear glass panel having a first polarizing filter included therein;
a plurality of liquid crystal sub-pixel elements;
a color filter array; and
a front glass panel having a second polarizing filter included therein.

17. The video system of claim 16, wherein the first polarizing filter comprises a first linear polarizing filter having a first polarization orientation, and wherein the second polarizing filter comprises:
a second linear polarizing filter having a second polarization orientation; and
a quarter-wave retarder.

18. The video system of claim 17, wherein the quarter-wave retarder comprises a first layer including a first plurality of regions of birefringent material having a third polarization orientation relative to the second polarization orientation and a second layer including a second plurality of regions of birefringent material having a fourth polarization orientation relative to the second polarization orientation, and wherein the first plurality of regions are located above the first set of sub-pixel elements and the second plurality of regions are located above the second set of sub-pixel elements.

19. The video system of claim 15, wherein the video source device comprises a computer system having a graphics processing unit (GPU) coupled to the display device via the video interface, and wherein the GPU is configured to:
transmit video signals to the display device that includes pixel data for one image channel when operating in a 2D mode, or
transmit video signals to the display device that includes pixel data for two image channels when operating in a 3D mode,
wherein the bandwidth associated with the video signals transmitted via the video interface in the 2D mode is approximately half the bandwidth associated with the video signals transmitted via the video interface in the 3D mode.

20. The video system of claim 15, wherein the video interface is an HDMI interface.
